(19) United States
(12) Patent Application Publication
(10) Pub. No.: US 2013/0067232 A1
(43) Pub. Date: Mar. 14, 2013

(54) METHOD AND SYSTEM FOR CREDENTIAL MANAGEMENT AND DATA ENCRYPTION FOR iOS BASED DEVICES

(71) Applicants: Kai Chung CHEUNG, Markham (CA); Christian PEEL, Aurora (CA); Sarah Heather Christine HAPPE, Pickering (CA)

(72) Inventors: Kai Chung CHEUNG, Markham (CA); Christian PEEL, Aurora (CA); Sarah Heather Christine HAPPE, Pickering (CA)

(21) Appl. No.: 13/228,930

(22) Filed: Sep. 9, 2011

(51) Int. Cl. H04L 9/32

(52) U.S. Cl. 713/176

(57) ABSTRACT

A mechanism and method for managing credentials on an electronic device and providing encryption and decryption services for the electronic device comprising a mobile communication device, smart phone or other computing device. According to an embodiment the device is configured with an iOS based operating system. The device is configured with a data encryption service application and an associated secure data repository. According to an embodiment, the electronic device is configured to download and/or cache credentials from a credential management system operatively coupled to the device, comprising public-private key pairs in a PKI system. According to an embodiment, the electronic device is configured with or stores a digital verification signature. The data encryption service application is configured to encrypt/decrypt data (e.g. files, documents) and optionally digitally sign the encrypted file. The encrypted (and digitally signed data) is contained in the sandbox associated with the data encryption service application.

### FIELD OF THE INVENTION

This invention relates to electronic devices, and more particularly to a method and system for providing credential management and/or data encryption for an electronic device configured with an iOS based operating system.

### BACKGROUND OF THE INVENTION

iOS (known as the iPhone™ Operating System) is a mobile operating system from Apple Inc. The iOS operating system was originally developed for the iPhone™ device. It has since been extended to other Apple devices such as the iPod™ touch device and the iPad™ tablet.

With the exception of a few special file types, such as photos and contacts, the iOS operating system restricts each application running under iOS to a dedicated location in the file system. This restriction is part of a security feature under iOS known as the application's “sandbox”. It is also found in other operating systems.

The sandbox is typically implemented as a set of fine-grained controls limiting an application's access to data (e.g. files and documents), preferences, network resources, hardware, and so on. Each application has access to the contents of its own sandbox but cannot access the sandboxes of any other applications.

One problem in the art is that operating systems can be modified, i.e. “jail-broken”, to circumvent the sandbox. This leaves data saved locally exposed to other rogue applications.

The iCloud™ service from the Apple Corporation provides online, i.e. “cloud”, storage for iOS application data. In manner similar to the restrictions on a local sandbox, each application is only given access to its own content uploaded to the iCloud™ service. Modification of the operating system, i.e. “jail-breaking”, can result in the sandbox restrictions on the iCloud™ service being circumvented and the uploaded data vulnerable to a rogue or malicious application.

Although cloud service providers, such as Apple iCloud™, Google™ Docs™ and DropBox™, typically encrypt online cloud content, cloud users have to rely on cloud service providers to safeguard the encryption key. As a result, when security measures (such as authentication) provided by a cloud service provider fails, data on the cloud is being exposed.

Accordingly, there remains a need for improvement in the art.

### BRIEF SUMMARY OF THE INVENTION

The present invention is directed to a method and system for providing credential management and/or data encryption services for an electronic communication device and other types of computing devices configured for an iOS based operating system.

According to an embodiment, the present invention comprises a device configured for communication over a network, the device comprises: an encryption module configured to encrypt and/or decrypt data utilizing credentials associated with the device; a component configured to retrieve the credentials; a component configured to store a digital signature and a component configured to sign the encrypted data using the digital signature and verify the digital signature; and a secure data repository configured on the device and associated with the encryption module to store the encrypted and signed data.

According to another embodiment, the present invention comprises a computer-implemented method for securing data associated with an application running on a device, said method comprising the steps of: encrypting the data; applying a digital signature to the encrypted data; configuring a secure data repository on the device; and storing the encrypted and signed data in the secure data repository configured on the device.

According to another embodiment, the present invention comprises a computer program product for securing data associated with an application running on a computing device, the computer program product comprising: a storage medium configured to store computer readable instructions; the computer readable instructions including instructions for, encrypting the data; applying a digital signature to the encrypted data; configuring a secure data repository on the device; and storing the encrypted and signed data in the secure data repository configured on the device.

Other aspects and features of the present invention will become apparent to those ordinarily skilled in the art upon review of the following exemplary embodiments of the invention in conjunction with the accompanying figures.

### BRIEF DESCRIPTION OF THE DRAWINGS

Reference will now be made to the accompanying drawings, which show by way of example, embodiments according to the present invention, and in which:

FIG. 1 is a flow-diagram showing a process for setting up a data encryption service according to an embodiment of the present invention;

FIG. 2 is a flow-diagram showing a process for encrypting, signing and uploading data to a data cloud according to an embodiment of the present invention;

FIG. 3 is a flow-diagram showing a process for encrypting, signing and saving data locally according to an embodiment of the present invention;

FIG. 4 is a flow-diagram showing a process for encrypting, signing and returning encrypted and signed data according to an embodiment of the present invention;

FIG. 5 is a flow-diagram showing a process for downloading data from a data cloud, verifying the signature and decrypting the data according to an embodiment of the present invention;

FIG. 6 is a flow-diagram showing a process for loading data locally, verifying the signature, decrypting and returning the data according to an embodiment of the present invention; and

FIG. 7 is a flow-diagram showing a process for receiving encrypted data, verifying the signature and decrypting the data according to an embodiment of the present invention.

Like reference numerals indicate like elements or components in the drawings.

### DETAILED DESCRIPTION OF THE EMBODIMENTS

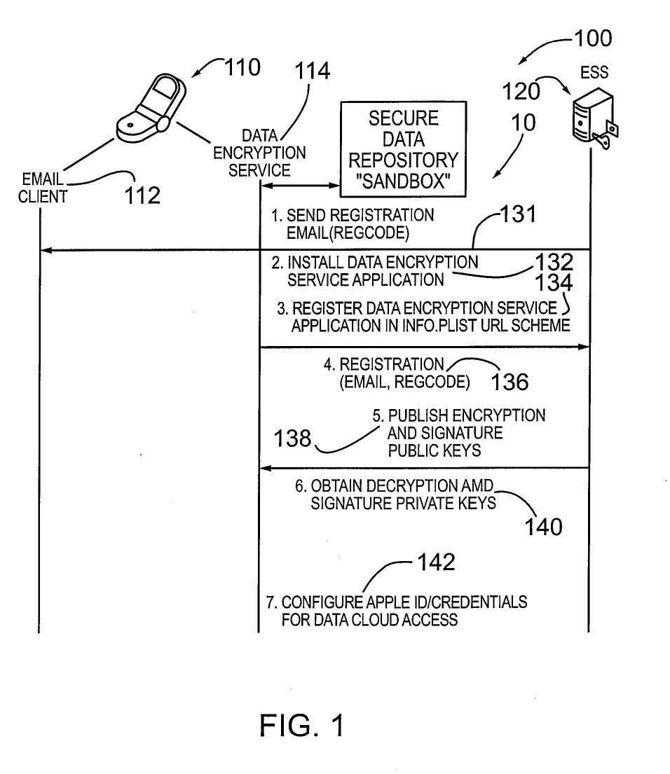

Reference is made to FIG. 1, which shows in diagrammatic form an exemplary system incorporating a mechanism and method for managing credentials and/or providing data encryption according to an embodiment of the invention, and indicated generally by reference 100.

The system 100 includes an electronic device 110 and a credential management system 120. The electronic device 110 and the credential management system 120 are operatively coupled for communication through a communication network indicated generally by reference 10. The electronic device 110 may comprise, for example, a “smart phone” such as the iPhone™ handheld device from Apple Inc., or another type of computing device such as an iPAD™ device, also from Apple Inc., a notebook computer, a desktop computer, etc.

In the present description, the data encryption system, mechanism and method is described in the context of an electronic device, or an electronic device configured with a communication capability or facility, running or based on the iOS operating system from Apple Inc. It will however be appreciated that the mechanism and/or method is suitable in part, or whole, to other operating systems or applications comprising a similar security structure or facility, or to other types of computing devices.

In FIG. 1, the communication device is indicated generally by reference 110 and can comprise an iPhone™ handheld device from Apple Inc., or an iPOD™ device or an iPAD™ device, also from Apple Inc. The device 110 is operatively coupled to a communication network and configured to transmit and receive email messages and other types of data and/or voice communications. According to an embodiment, the communication network comprises a wide area wireless network, for example, a cellular network. According to an embodiment, the communication network provides Internet access. One or more email servers, e.g. remote servers, (not shown) are operatively to the communication network either through the Internet or directly through a transceiver (not shown). According to another exemplary implementation, the device 110 is operatively coupled to a local area network or LAN, for example, a wireless LAN (WLAN), WI-Fi or Bluetooth based connection. One or more email servers (not shown) are operatively coupled to the wireless WLAN. In known manner, the communication networks provide the capability for the device 110 to transmit and receive email messages and other types of messages or data communications from the remote or local remote servers, for example, configured as email servers.

As shown in FIG. 1, the device 110 is configured to run the iOS operating system and comprises a wireless communication module or interface. The wireless communication module is implemented and configured in known manner, and provides the capability for the device 110 to interface with the communication network as described above. The device 110 includes an email module or client or application indicated generally by reference 112. The email module 112 is configured in known manner to provide the capability or facility to compose, transmit, receive and otherwise manage email communications and other types of communications or data messages. The device 110 according to an embodiment of the present invention is configured with a data encryption service application indicated generally by reference 114. Based on the iOS implementation, the device 110 includes a sandbox. The sandbox comprises a secure data repository, for example, configured in local device memory, and can be associated with one of the applications (i.e. Apps) installed on the device 110. According to an embodiment, a sandbox is configured and utilized for the data encryption service application 114. The data encryption service application 114 is configured under the iOS operating system to operate with the sandbox and provide a secure depository for storing data as described in more detail below, and is typically application specific.

According to an exemplary embodiment, the device 110 and the data encryption service application 114 are configured to function with a SasS based credential management system such as the ESS system available from Echoworx Corporation in Toronto, Ontario, CANADA, and indicated generally by reference 120 in FIG. 1. According to an exemplary embodiment, the credential management system 120 is configured to operate as a Web-based service. The data encryption service 114 is configured to provide associated security functions, such as, key management, policy enforcement, data encryption and decryption, as will be described in more detail below.

As shown in FIG. 1, the system 100 is configured with a process to set up or configure the data encryption service according to an embodiment of the present invention. The first step in the process comprises receiving a registration email from the credential management system 120, as indicated by reference 131. According to an embodiment, the registration email is configured or includes a registration code (RegCode). The next step indicated by reference 132 comprises installing the data encryption service application 114 on the device 110. According to this aspect, the data encryption service application 114 can be downloaded to the device 110 and installed through an installation script, or in the alternative pre-installed on the device 114. For an iOS based device 110, the installation script can be configured to register the data encryption service 114 to “info.plist URL” as indicated by reference 134. This provides the capability for other applications on the device 110 to exchange files utilizing the data encryption service application 114. According another embodiment for other types of computing devices, such as, devices running the BlackBerry™ operating system or OS, the Android™ operating system or the Windows Phone™ operating system, the system 100 is configured with the appropriate native inter-process communication mechanism or process for the sending and receiving of data between the respective applications. The next step in the set-up or configuration process is the registration step indicated by reference 136 and comprises emailing or transmitting the RegCode to the credential management system 120 via its Web-based service. The credential management system 120 is configured to check or verify the RegCode. If the registration code is incorrect, then the online registration process fails, and the credential management system 120 does not provision keys for the device 110. The next step indicated by reference 138 comprises the credential management system 120 generating and publishing encryption and signature public keys for the user associated with the device 110. The credential management system 120 is configured to send corresponding decryption and signature private keys to the data encryption service application 114 as indicated by reference 140. For an iOS based operating system, the device 110 is configured to store or save the decryption and signature private keys in a local iOS keychain as will be understood by one skilled in the art. For other types of operating systems, the device 114 is configured to store or save the keys in a native implementation of a private keychain or similar mechanism, as will also be within the understanding of one skilled in the art. According to another aspect, the set-up process comprises configuring an “Apple™ ID” or credential associated with the device 110 in the data encryption service application 114 in order to enable iCloud™ cloud access, as indicated generally by reference 142. Without a valid Apple™ ID or credential, the data cloud service is not available. For other types of operating systems or other types of cloud or data services, the corresponding credentials can be configured in the data encryption service application 114 to provide access. Once the set-up process is completed, the device 114 is configured for secure data operations as will be described in more detail below.

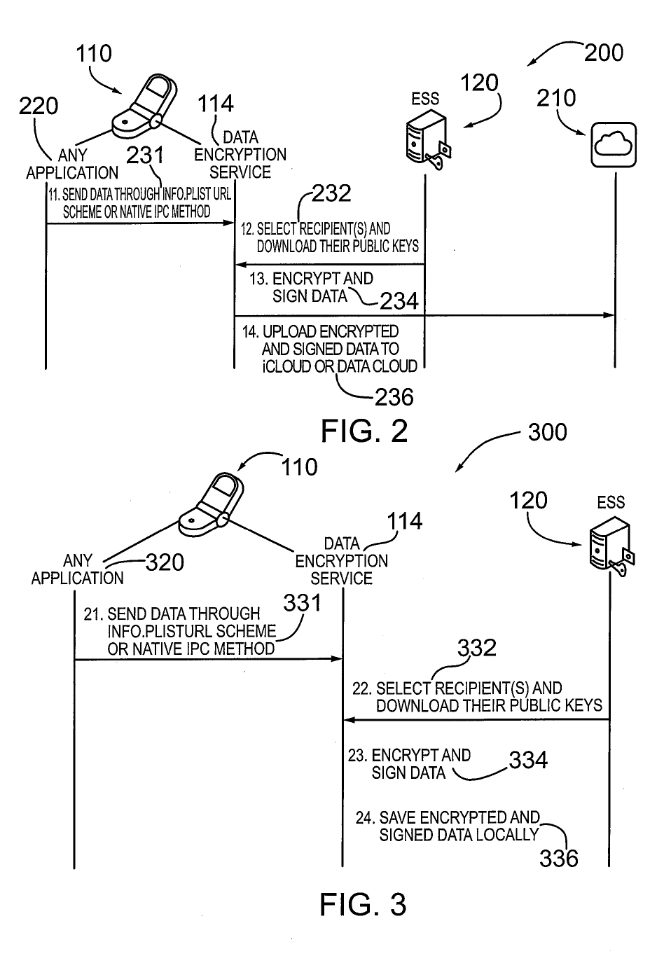

Reference is next made to FIG. 2, which shows in diagrammatic form a system configuration and process for encrypting, signing and uploading data to a data cloud or similar service. The system is indicated generally by reference 200 and comprises the device 110 configured with the data encryption service application 114, the credential management system 120 and a data cloud or other type of data service. The data cloud or cloud is indicated generally by reference 210 in FIG. 2. According to an embodiment, the system 200 is configured with a process to provide a user with the capability to encrypt, sign and upload data (e.g. files, documents and other types of electronic data) from an application 220 (e.g. an “App” running on the device 110 or computing device) to the data cloud 210 (e.g. the iCloud™ data cloud service from Apple™ Inc.). According to an embodiment, the first step in the process comprises the application 220 invoking the data encryption service application 114, and utilizing an info.plist URL mechanism (or another appropriate native inter-process communication method) for sending the data to the data encryption service 114, as indicated by reference 231. The next step comprises the user of the device 110 selecting the intended recipient(s) of the data, and if required, downloading the necessary credentials, e.g. the public keys, from the credential management system 120, as indicated by reference 232. According to another aspect, the credentials, e.g. the public keys, are cached on the device 110 (i.e. the smart phone or computing device). The next step in the process comprises encrypting the data utilizing the intended recipient(s) public keys as indicated by reference 234. The data is encrypted using known techniques or mechanisms, for example, PKI (Public Key Infrastructure) and using public and private encryption/decryption key pairs, and the data encryption service application 114 or device 110 is suitably configured with an encryption mechanism or application, as will be within the understanding of those skilled in the art. According to an embodiment, the encryption step 234 can include the step of signing the data with a digital signature or signing private key. Upon completion of the encryption operation, the encrypted (and signed) data is uploaded or transmitted to the data cloud 210, as indicated by reference 236. According to another aspect, the system and process are configured for one or more of the following exception conditions or events. If the encryption private key has expired, the data encryption service application 114 is configured to terminate the encryption process. If the signature private key has expired, then the data encryption service application 114 is configured not to proceed with the digital signing operation or step as described above. If the data cloud 210, e.g. iCloud™ data cloud, requires a valid credential, e.g. Apple™ ID, and the credential is not available or expired, then the data cloud service will not be available. The data cloud service 210 may also not be available due to network outage, insufficient storage space or other service related events.

Reference is next made to FIG. 3, which shows in diagrammatic form a system configuration and process for encrypting, signing and saving data locally at the device 114, e.g. a smart phone or other type of computing device, according to an embodiment of the invention. The system as configured is indicated generally by reference 300 and comprises the device 110 configured with the data encryption service application 114 and one or more other applications indicated by reference 320. The system is configured with a process to provide the user with the capability to encrypt, sign and locally save data (e.g. files, documents and other types of data). According to an embodiment, the first step in the process comprises the application 320 invoking the data encryption service application 114, and utilizing an info.plist URL mechanism (or another appropriate native inter-process communication method) for sending the data to the data encryption service 114, as indicated by reference 331. The next step comprises the user of the device 110 downloading the necessary credentials, e.g. the public keys, from the credential management system 120, as indicated by reference 332. According to another aspect, the credentials, e.g. the public keys, are cached on the device 110 (i.e. the smart phone or computing device). The next step in the process comprises encrypting the data utilizing the public and private key pair(s) as indicated by reference 334. The data is encrypted using known techniques or mechanisms, for example, PKI (Public Key Infrastructure) and using public and private encryption/decryption key pairs, and the data encryption service application 114 or device 110 is suitably configured with an encryption mechanism or application, as will be within the understanding of those skilled in the art. According to an embodiment, the encryption step 334 includes the step of signing the data with a digital signature or signing private key. Upon completion of the encryption operation, the encrypted data (and signed data) is stored in local memory on or associated with the device 110. For instance, in an iOS implementation, the encrypted (and signed) data is stored within a “sandbox” file system configured on the device 110. According to another aspect, the system 300 and process are configured for one or more of the following exception conditions or events. If the credential management system 120 is not available or inaccessible, e.g. offline, then the data encryption service application 114 will not be able to retrieve the credentials (e.g. public keys) for other recipients or users. If the encryption private key has expired, the data encryption service application 114 is configured to terminate the encryption process. If the signature private key has expired, then the data encryption service application 114 is configured not to proceed with the digital signing operation or step as described above. If the local storage space (e.g. memory) is insufficient, then encrypted (and signed) data cannot be properly stored or saved.

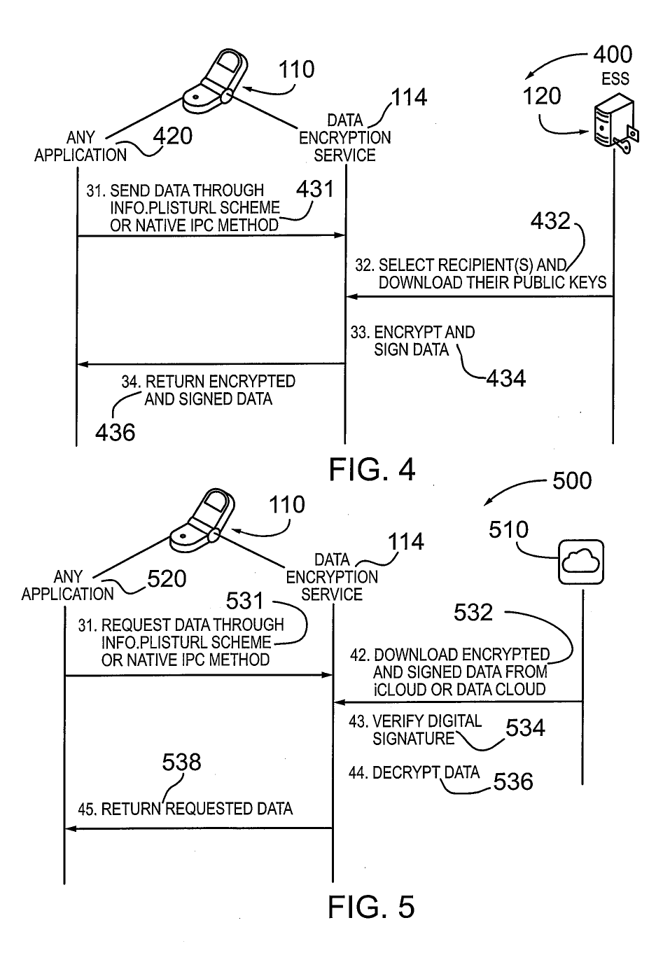

Reference is next made to FIG. 4, which shows in diagrammatic form a system configuration and process for encrypting and signing data for an application running on the device 110 according to an embodiment of the invention. The system as configured is indicated generally by reference 400 and comprises the device 110 configured with the data encryption service application 114 and one or more other applications indicated by reference 420. The system is configured with a process to provide the user with the capability to encrypt, sign and save data (e.g. files, documents and other types of data) from the application 420 running on the device 110. According to an embodiment, the first step in the process comprises the application 420 invoking the data encryption service application 114, and utilizing an info.plist URL mechanism (or another appropriate native inter-process communication method) for sending the data to the data encryption service 114, as indicated by reference 431. The next step comprises the user of the device 110 downloading the necessary credentials, e.g. the public keys, from the credential management system 120, as indicated by reference 432. According to another aspect, the credentials, e.g. the public keys, are cached on the device 110 (i.e. the smart phone or computing device). The next step in the process comprises encrypting the data utilizing the public and private key pair(s) as indicated by reference 434. The data is encrypted using known techniques or mechanisms, for example, PKI (Public Key Infrastructure) and using public and private encryption/decryption key pairs, and the data encryption service application 114 or device 110 is suitably configured with an encryption mechanism or application, as will be within the understanding of those skilled in the art. According to an embodiment, the encryption step 434 can include the step of signing the data with a digital signature or signing private key. Upon completion of the encryption operation, the encrypted data (and signed data) is returned to application 420. According to another aspect, the system 400 and associated process are configured for one or more of the following exception conditions or events. If the credential management system 120 is not available or inaccessible, e.g. offline, then the data encryption service application 114 will not be able to retrieve the credentials (e.g. public keys) for the user or other recipients or users. If the encryption private key has expired, the data encryption service application 114 is configured to terminate the encryption process. If the signature private key has expired, then the data encryption service application 114 is configured not to proceed with the digital signing operation or step as described above.

Reference is next made to FIG. 5, which shows in diagrammatic form a system configuration and process for downloading data from a data cloud service and verifying the signature and decrypting the data, according to an embodiment of the invention. The system is indicated generally by reference 500 and comprises the device 110 configured with the data encryption service application 114, the credential management system 120 and a data cloud or other type of data service indicated generally by reference 510. According to an embodiment, the system 500 is configured with a process to provide a user with the capability to download data from the data cloud 510, verify the signature and decrypt the data. The data comprises files, documents and other types of electronic data, for one or more applications 520, e.g. “Apps”, running on the device 110 or computing device. According to an exemplary implementation, the data cloud 510 comprises the iCloud™ data cloud service from Apple™ Inc. According to an embodiment, the first step in the process comprises the application 520 invoking the data encryption service application 114, and utilizing an info.plist URL mechanism (or another appropriate native inter-process communication method) for requesting the data from the data encryption service 114, as indicated by reference 531. The next step comprises the data encryption service application 114 requesting and downloading the encrypted (and signed) data from the data cloud service 510, as indicated by reference 532. The next step in the process comprises verifying the digital signature for the downloaded data as indicated by reference 534, which is followed by the decryption of the data utilizing the public-private encryption key pair(s), as indicated by reference 536. If the data has not been digitally signed, then the signature verification processing step can be omitted. The data is decrypted using known techniques or mechanisms, for example, PKI (Public Key Infrastructure) and using public and private encryption/decryption key pairs, and the data encryption service application 114 or device 110 is suitably configured with an encryption mechanism or application, as will be within the understanding of those skilled in the art. According to an embodiment, the decryption private key(s) for the user and/or device 110 are downloaded from the credential management system 120 (FIG. 1). According to another aspect, the credentials, e.g. the keys, are cached on the device 110 (i.e. the smart phone or computing device). Upon completion of the decryption operation, the data encryption service application 114 is configured to return the decrypted data to the requesting application 520, as indicated by reference 538. According to another aspect, the system and process are configured for one or more of the following exception conditions or events. If the digital signature is invalid, then the data encryption service application 114 is configured to warn the user not to proceed with the decryption as described above. If the local storage, i.e. memory capacity, is exceeded or insufficient, the process to download the encrypted (and signed) data is suspended or terminated. If the data cloud 510, e.g. iCloud™ data cloud, requires a valid credential, e.g. Apple™ ID, and the credential is not available or expired, then the data service will not be available. Similarly, if the data cloud service 510 is off-line or otherwise unavailable, then the process is suspended or rescheduled.

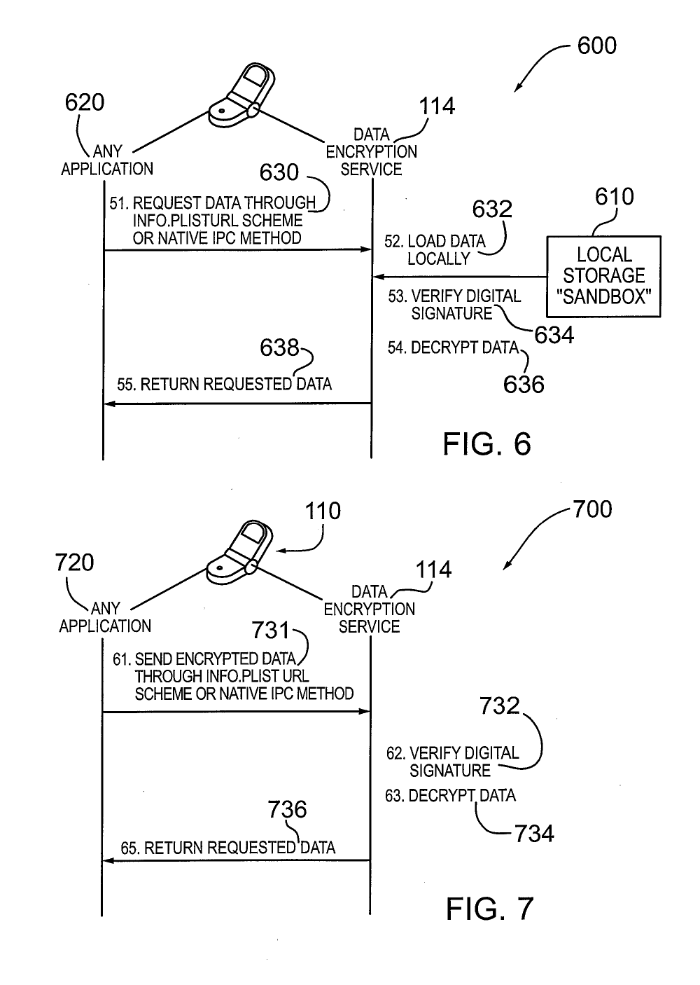

Reference is next made to FIG. 6, which shows in diagrammatic form a system configuration and process for locally loading encrypted data, verifying the digital signature and decrypting the data, according to an embodiment of the present invention. The system configuration is indicated generally by reference 600 and comprises the device 110 (e.g. mobile communication device, smart phone or other type of computing device) configured with the data encryption service application 114. According to an embodiment, the device 110 is configured with a local secure data repository or secure memory, indicated generally by reference 610. According to an exemplary implementation, the device 110 comprises an iPhone™ smart phone and the secure local data storage 610 comprises a “sandbox” configured under the iOS™ operating system as will be within the understanding of one skilled in the art. In known manner, the sandbox 610 is configured for the data encryption service application 114. The first step in the process as indicated by reference 630 comprises the application 620 invoking the data encryption service application 114, and utilizing an info.plist URL mechanism or another appropriate native inter-process communication method. The next step comprises the data encryption service application 114 requesting and loading the encrypted (and signed) data from the local data repository or storage medium 610, i.e. the “sandbox” configured under iOS operating system, as indicated by reference 632. The next step in the process comprises verifying the digital signature for the loaded data as indicated by reference 634, which is followed by decrypting the data utilizing the public-private encryption key pair(s), as indicated by reference 636. If the data has not been digitally signed, then the signature verification processing step can be omitted. The data is decrypted using known techniques or mechanisms, for example, PKI (Public Key Infrastructure) and using public and private encryption/decryption key pairs, and the data encryption service application 114 or device 110 is suitably configured with an encryption mechanism or application, as will be within the understanding of those skilled in the art. According to an embodiment, the decryption private key(s) for the user and/or device 110 are downloaded from the credential management system 120 (FIG. 1). According to another aspect, the credentials, e.g. the keys, are cached on the device 110 (i.e. the smart phone or computing device). Upon completion of the decryption operation, the data encryption service application 114 is configured to return the decrypted data to the requesting application 620, as indicated by reference 638. According to another aspect, the system and process are configured for one or more of the following exception conditions or events. If the digital signature is invalid, then the data encryption service application 114 is configured to warn the user not to proceed with the decryption as described above.

Reference is next made to FIG. 7, which shows in diagrammatic form a system configuration and process for verifying the digital signature and decrypting data, according to an embodiment of the present invention. The system configuration is indicated generally by reference 700 and comprises the device 110 (e.g. mobile communication device, smart phone or other type of computing device) configured with the data encryption service application 114 and an application or App indicated by reference 720. The first step in the process as indicated by reference 731 comprises the application 720 invoking the data encryption service application 114, and utilizing an info.plist URL mechanism or another appropriate native inter-process communication method. The next step in the process, i.e. implemented in one or more code components in the data encryption service application 114, comprises verifying the digital signature associated with the user and/or the device 110 as indicated generally by reference 732, which is followed by decrypting the data utilizing the public-private encryption key pair(s), as indicated by reference 734. If the data has not been digitally signed, then the signature verification processing step can be omitted, in some implementations, the digital signature can be an optional step or operation. The data is decrypted using known techniques or mechanisms, for example, PKI (Public Key Infrastructure) and using public and private encryption/decryption key pairs, and the data encryption service application 114 or device 110 is suitably configured with an encryption mechanism or application, as will be within the understanding of those skilled in the art. According to an embodiment, the decryption private key(s) for the user and/or device 110 are downloaded from the credential management system 120 (FIG. 1). According to another aspect, the credentials, e.g. the keys, are cached on the device 110 (i.e. the smart phone or computing device). Upon completion of the decryption operation, the data encryption service application 114 is configured to return the decrypted data to a requesting application 720, as indicated by reference 736. According to another aspect, the system and process are configured for one or more of the following exception conditions or events. If the digital signature is invalid, then the data encryption service application 114 is configured to warn the user not to proceed with the decryption as described above.

In summary and according to an embodiment there is provided a device configured for communication over a network, the device comprises, an encryption module configured to encrypt data utilizing credentials associated with the device; a component configured to retrieve the credentials; a component configured to store a digital signature and a component or module configured to sign the encrypted data using the digital signature; and a secure data repository configured on the device and associated with the encryption module to store the encrypted and signed data.

The present invention may be embodied in other specific forms without departing from its spirit or essential characteristics. The embodiments described and disclosed are to be considered in all aspects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A device configured for communication over a network, said device comprising:
an encryption module configured to encrypt and/or decrypt data utilizing credentials associated with the device;
a component configured to retrieve said credentials;
a component configured to store a digital signature;
a component configured to sign said encrypted data using said digital signature; and
a secure data repository configured on the device and associated with said encryption module to store said encrypted and signed data.

2. The device as claimed in claim 1, further including a component configured for verifying said digital signature.

3. The device as claimed in claim 1, wherein said credentials are retrieved from a credential management system.

4. The device as claimed in claim 1, further including a component configured to upload and/or download said encrypted and signed data to/from a data cloud service.

5. The device as claimed in claim 1 configured with an application and further including a component configured to return said encrypted and signed data to said application.

6. The device as claimed in claim 1, configured with an operating system comprising iOS operating system and said secure data repository comprising a sandbox configured under said iOS operating system.

7. A computer-implemented method for securing data associated with an application running on a device, said method comprising the steps of:
encrypting the data;
applying a digital signature to said encrypted data;
configuring a secure data repository on the device; and
storing said encrypted and signed data in said secure data repository configured on the device.

8. The computer-implemented method as claimed in claim 7, wherein said step of storing said encrypted and signed data comprises uploading said encrypted and signed data to a data service remote from the device.

9. The computer-implemented method as claimed in claim 7, wherein the device is configured with an operating system comprising iOS and said secure data repository comprises a sandbox configured under the iOS operating system.

10. The computer-implemented method as claimed in claim 9, wherein the device comprises a mobile communication device.

11. The computer-implemented method as claimed in claim 9, wherein credentials including said digital signature are obtained from a credential management system.

12. The computer-implemented method as claimed in claim 8, wherein the device is configured with an operating system comprising iOS and said secure data repository comprises a sandbox configured under the iOS operating system, and the data service comprises an iCloud data service remote from the device.

13. The computer-implemented method as claimed in claim 7, further including the steps of: loading said encrypted and signed data from said secure data repository, decrypting the data and verifying said digital signature and making the data available for the application.

14. The computer-implemented method as claimed in claim 8, further including the steps of downloading said encrypted and signed data from said remote data service, decrypting the data and verifying said digital signature and making the data available for the application.

15. The computer-implemented method as claimed in claim 14, wherein the device is configured with an operating system comprising iOS and said secure data repository comprises a sandbox configured under the iOS operating system, and the data service comprises an iCloud data service remote to the device.

16. The computer-implemented method as claimed in claim 7, wherein the device is configured to run two or more applications, and further including an inter-process communication step for transferring data between said two or more applications.

17. A computer program product for securing data associated with an application running on a computing device, said computer program product comprising:
a storage medium configured to store computer readable instructions;
said computer readable instructions including instructions for, encrypting the data;
applying a digital signature to said encrypted data; and
storing said encrypted and signed data in a secure data repository configured on the device.

18. The computer program product as claimed in claim 17, wherein the device is configured with an operating system comprising iOS and said secure data repository comprises a sandbox configured under the iOS operating system.

19. The computer program product as claimed in claim 17, wherein said instructions for storing said encrypted and signed data comprises instructions for uploading said encrypted and signed data to a data service remote from the device.

20. The computer program product as claimed in claim 19, wherein the device is configured with an operating system comprising iOS and said secure data repository comprises a sandbox configured under the iOS operating system, and the data service comprises an iCloud data service remote from the device.
